(19) United States
(12) Patent Application Publication
(10) Pub. No.: US 2015/0332176 A1
(43) Pub. Date: Nov. 19, 2015

(54) TRAVEL COMFORT INDEX

(71) Applicant: SERKO LIMITED, Auckland (NZ)

(72) Inventor: Robert James SHAW, Auckland (NZ)

(73) Assignee: SERKO LIMITED, AUCKLAND (NZ)

(21) Appl. No.: 14/653,537

(22) PCT Filed: Dec. 17, 2013
(86) PCT No.: PCT/NZ2013/000236

§ 371 Date: Jun. 18, 2015

(30) Foreign Application Priority Data
Dec. 18, 2012 (NZ) 604874

(51) Int. Cl. G06Q 10/02; G06F 17/30

(52) U.S. Cl. CPC G06Q 10/02; G06F 17/3087

(57) ABSTRACT

A travel booking system calculates the comfort level of a traveller for a trip by including factors for each sector of a trip, such as an aircraft seat pitch and seat width, the flight time of a flight sector, the travel distance at any airport transits en route, the confusion level at an airport, the facilities available at a hotel, the cost of the trip, the corporate travel requirements, the travellers own preferences, and factoring these together by a process as shown to arrive at an overall comfort level. From this alternative travel routes can be compared to allow a choice of a trip route which will be as comfortable as possible and meet a required cost level.

### TECHNICAL FIELD

The invention generally relates to the provision of a system for booking travel where the booking takes into account the comfort level of the proposed trip.

More particularly the invention relates to the providing an assistant to the booking process which will provide a score for the comfort level of the proposed trip.

### BACKGROUND ART

Travel booking systems for corporates often form part of an Enterprise Resource Planning (ERP) system which oversees corporate planning of personnel travel and all corporate expenses including travel.

An ERP system typically is made up of a transactional database with software modules to handle one or more of the functions required. Interaction with the modules is typically by a web interface and the database and modules may be part of a cloud computing system.

The present invention is intended to deal with the situation in which an enterprise employee, manager or director is booking travel using the ERP system and wishes to find the travel choice which delivers them to the required destination at the required time, in the best condition and at the least expense.

Current systems provide for arriving at the required destination before the required time and at the minimum expense but are unable to do more than rely on the bookers knowledge of what condition the traveller is likely to be in at the end of the trip.

Not unusually a travel system will book the cheapest travel which will get the traveller to the required destination without regard for travellers comfort. Not unusually a traveller will be booked through transfers at one or two intermediate airports between the original boarding point and the final destination. At each of these transfers the traveller may find that a bus trip to another terminal is required, or that a three or four hour wait in a lacklustre terminal is required. The aircraft in which the traveller is booked may prove to have a very low seat pitch and exceptionally narrow seats without full reclining. Naturally this reflects on the state of the traveller at the final destination and may leave them in an unrested state for whatever meeting they have at the destination.

The present invention provides a solution to this and other problems which offers advantages over the prior art or which will at least provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

A reference to an “ERP” is a reference to an Enterprise Resource Planning system including at least an accounting system and a corporate travel planning system including itinerary planning and expenditure capability.

A reference herein to “comfort” does not entirely relate to creature comfort, but rather to the combination of factors which will be seen by a traveller as contributing towards providing a stress free journey in an environment with no extraneous problems impinging on the inevitable minor annoyances provided by travelling from one place to another. Such factors are the risk level associated with a trip, the stress and fatigue levels likely to be reached during the trip, the available creature comforts of the trip, the degree of confusion at each travel centre on the trip, the number of time zones traversed in the journey, the degree to which the travellers normal wants are provided for during the journey.

A reference to a “level of comfort” implies a measurement of the degree of ease, timeliness, security, safety and contentment associated with journeys or trips or various sectors of journeys or trips.

### SUMMARY OF THE INVENTION

In one exemplification the invention consists in providing a travel booking method which identifies the expected level of comfort of a travellers journey from one place to another when planning a travel route by identifying each sector of travel within that route, identifying the expected level of comfort of a traveller within that sector of travel, calculating the expected levels of comfort of each route and comparing travel routes made up of sectors of travel using standard statistical measures to indicate a travel route as that which provides a preferred expected level of comfort to the traveller.

Preferably the factors of time, comfort, stress and risk associated with a trip are reduced to numerical factors in planning a trip.

Preferably the trip cost is an additional factor in arriving at a preferred level of comfort for a journey.

Preferably the statistical measures include a standard deviation calculation of the sum of individual factors.

In a second embodiment the invention may consist in a travel booking system having a storage system retaining information on:
sectors of travel journeys;
   the information including at least some of:
      the travel time of each sector of a journey;
      the distance of each sector of a journey;
      the percentile traveller build limitations of each sector of a journey;
      the facilities available within each sector of a journey,
      the degree of confusion associated with being a traveller in each sector of a journey,
      the number of time zones covered in each sector of a journey,
      the risk associated with each sector of a journey;
a traveller profile including at least some of:
   the traveller physical build percentile;
   the traveller special food requirements;
   the traveller special travel requirements;
   the traveller special accommodation requirements;
a calculator calculating for each sector of a journey the potential level of comfort of the traveller within each sector on the basis of at least the specified factors,
an averaging mechanism calculating the potential levels of comfort of the complete journey,
a display displaying the calculated potential level of comfort for the journey.

Preferably the travel booking system may provide a display of the potential comfort levels of each sector and the factors making up that sectors potential comfort level.

Preferably the display of the potential levels of comfort of the whole journey include calculations of the standard deviation of the sectors and the factors making up the sectors.

Preferably the travel booking system includes a calculation of the risk level of each sector.

Preferably the factors making up the potential comfort level are presented as a statistical compilation producing a single indicator for each journey.

These and other features of as well as advantages which characterise the present invention will be apparent upon reading of the following detailed description and review of the associated drawings.

### BRIEF DESCRIPTION OF THE DRAWINGS

FIG. 1 is a general illustrative view of the area of operation of the invention and the source of the data required.

FIG. 2 is a flow chart of the method of deriving an indicator for differing travel options.

FIG. 3 is a diagram of the procedures which combine to provide the information for the travel options and to derive the differing options.

### DESCRIPTION OF THE INVENTION

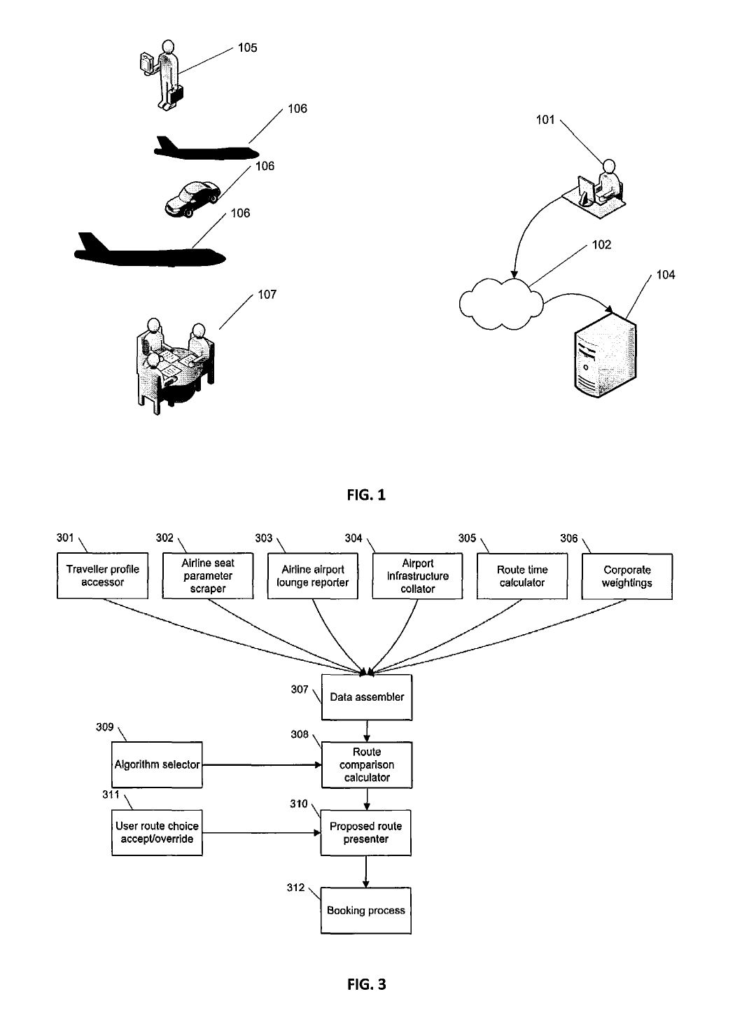

FIG. 1. shows at 101 the booking assistant for a corporate body who books travel through an internet connection 102 using a remote ERP system on corporate server 104. The travel is for a corporate executive 105 to travel on one or more aircraft, taxis, trains etc 106 to a destination meeting 107.

The corporate executive 105 has a stored profile on the corporate server 104 which notes that he is a lower level executive, of average height and weighs a nominated 102 Kg. He requires vegetarian meals and has no known allergies.

The trip is from Auckland, New Zealand to London, must start on the 14^{th} of January and must allow the executive to be at a meeting in London 2 hours from the airport on 16^{th} January.

The booking assistant queries the booking system and finds alternate routes via a transfer in Sydney and thence to Dubai and another transfer; via HongKong direct, via Narita with a transfer, via Vancouver with a transfer, via Los Angeles direct and via Los Angeles with a transfer to a second transfer stop at New York. The last is the cheapest, and will get the executive 105 to the meeting with three hours to spare. The assistant books that route.

An irate senior executive consults the booking assistant about booking his staff, with aspersions thrown in. The first transfer at Los Angeles requires the traveller to change terminals with barely enough time to go through US Customs twice; the trip to New

York is in economy class with an airline famed for its 17 inch wide seats at an ungenerous 30 inches pitch; the executive will have to spend six hours in transfer at New York at an early hour in the morning, and the final leg of the journey is on an airline whose business class seats do not fully recline. It is clear that the traveller will arrive at the meeting direct from the airport without having had a chance to sleep on the journey and will probably be unable to stay awake through the meeting.

The booking assistant is educated in the use of a system augmentation incorporating the current invention. This augmentation includes the ability to extract using third party web services as much information as possible about any flight, plus information including the seating and other facilities on all aircraft types operated by that airline and store it in the corporate server. Additionally the system stores information about every major airport indicating at which terminal each airlines flights are located, the degree of crowd confusion at peak times, the time it takes to get to and from a flight gate, the time it takes to transfer between terminals, the average time to clear immigration and customs going either in or out. It may additionally include risk factors peculiar to airports and risk factors peculiar to the country in which the airport is located and items which affect the duty of care a corporate employer may have for an employee.

The ERP system on server 104 has applications capable of locating and extracting information relating to airline seating (such as is found, for instance on http://www.seatguru.com). This and other information may be retrieved by web service from one or more third parties. Information on which airport terminal serves which airline can be normally be collated from the airport web site, information on what facilities are available at which airline members lounge at which airport are available from the airlines. Some information must be gathered from other corporate members, such as the facilities and quality of the transfer area at various airports.

Similarly information may be gathered on the risks of taking various different airlines; the possibility of catching a disease in a transfer between terminals; the likelihood of being mugged in a late night arrival hall . . . .

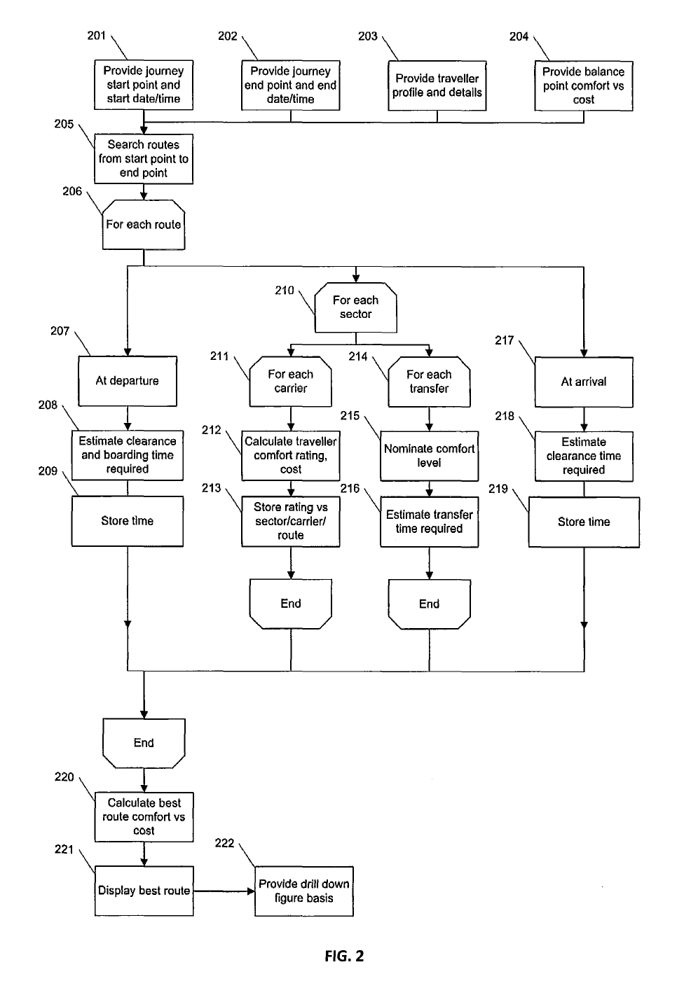

FIG. 2 shows how the information is used in providing an estimate of a travellers comfort level. The ERP adds to the normal booking software routines which accept at 201 the journey start point and datetime, and at 202 the journey end point and datetime, the identification of the travellers stored profile at 203, allowing return of the details from that profile, and at 203 an algorithm which will balance the travellers comfort level against the corporate cost. Typically the balance point will change with the seniority of the corporate member, so that a senior executive officer will have a higher comfort level and cost threshold than an assistant financial officer.

In the usual manner the ERP travel software will search at 205 for routes between origin and destination which meet the required period. Before presenting these to the person booking the travel the system will for each route found at 206, extract the factors contributing to the comfort level of the trip. Thus at 207 at departure the system can provide an estimate of the time required to clear emigration and customs and at 208 the time to proceed to the likely flight gate at the airport of origin. This estimate is stored at 209 as one factor in the eventual calculation.

At 210 for each sector on the proposed route, using the proposed class of fare on the proposed carrier the system retrieves those factors relevant to comfort considering first the flight on that sector, and then the transit procedure at the end of the flight, if there is one. Flight factors include the seat width and row pitch, the available degree of recline or sleeping space available, the cabin service, the availability of special meals, the quality of the online entertainment, the availability of power sources for electronic devices. These things are rated at 212 based on the stored values for the particular airline concerned, including past feedback from staff and others, and stored at 213. As an additional factor the number of time zones transitted through may be stored, providing an additional stress factor for a traveller.

Similarly the expected experience in transferring from one flight or airline to another is estimated for each transfer 214 in terms of the comfort level while transferring, which may include a bus trip, a wait at an airline members lounge, a shower, a meal and a wait at an airport gate lounge, as well as another security check at departure. Additionally the time required for the transfer is estimated at 216 and added to the stored information.

At the destination 217 an estimated clearance time which includes deplaning, passing immigration, collecting baggage and passing customs service may be estimated and added as a comfort level at 218 and added to the estimate at 219.

If onwards local travel is required by taxi, rail or rental car this is treated as a further sector and similarly scored in terms of comfort level. The accommodation at a journeys end may similarly be treated as a sector and scored in a similar manner on noise, level of furnishings, room service, closeness to transport, etc.

Once each route has been analysed for each sector the system is left with an array of values associated with comfort levels for each sector, for each transfer between sectors and for the origin and destination phases. Bearing in mind that the initial route provided was aimed at a particular expenditure level, that level being associated with a particular expected comfort level it is possible to derive a time/comfort figure for each of these routes.

Many different algorithms can be created to rate the perceived comfort of the whole travel event, but the expectation is that any part of a sector at a drastically reduced comfort level will provide an overall score for a route which is unacceptable in normal circumstances. For instance a route which provides comfortable unstressed travel for three flights with two short transfers may not be selected if one of the transfers is at a backwoods airport which has successfully lost the luggage of two company executives in the past and therefore receives a very low rating as a transfer centre.

Such factors are taken into account at 220 in calculating the best choice in terms of comfort and stress, and the result is displayed as a single figure at 221. Where more information on how the single figure was arrived at is required the application displaying the data may respond to a cursor click or a hovering cursor to provide a drill-down version of the information stored. Provision may be made for opting out of the choice or taking some other choice of routes at the users preference.

The system which produces the scores for routes, sectors, transits, arrivals and departures forms part of the ERP and consists of features as described in FIG. 3 which include at 301 a traveller profile accessor to access the profile of a particular corporate traveller and extract their approved level of corporate expenditure for a trip, their preferences in meals, their experience in travelling, their experience in carrying out transfers through particular airports and various other factors which may affect the weighting of the various factors involved in travel.

At 302 the system provides an airline seat scraper or similar third part product to gather details of the seating on various aircraft types on the different airlines, and information on what aircraft type operates particular sectors for that airline.

A reporter on airline lounges at 303 provides details of the facilities available in the various airline lounges at airports around the world, including communication and rest facilities. At 304 an airport infrastructure collator assembles details of airports including the transit time between terminals on good and bad days, the facilities available to transit passengers, the likely delay on arrival and departure, the degree of security for incoming or transit travellers, etc.

At 305 is provided a route time calculator which takes information from other sources to provide an overall travel time for any particular route with any airline. Finally, at 306 the weightings provided by previous corporate travellers are added to the number of variable factors provided. These are all gathered at 307 by a data assembler and passed to the route comparison calculator 308 which applies algorithms from an algorithm selector at 309 to firstly calculate the comfort levels for sectors of a route, transits within a route and the departure and arrival phases of a route to derive the results firstly for each route singly and then to compare all the routes found and calculated to derive a leading route.

At 310 this leading route is displayed to the person booking the travel, and allows them to either accept it or to dig deeper into the data for that route and for all the other routes found and eventually to accept one of them or perhaps to start again with some differing parameters for the travellers requirements such as the arrival time.

Each step of calculating the comfort level preferably uses a simple figure as the indicator of comfort for any individual item, any sector, or any route, though this is not a requirement to achieve a result from such a system. Figures given for various comfort levels are at the users or corporate choice. Typically, comfort levels may be rated from 0 for impossible through 5 for acceptable to 10 for a perfect feature of a trip.

A flight with inadequate leg room may degrade a comfort level down to a 5, a seat which cramps a drastically overweight traveller may cause that traveller to require a 20 inch or greater width seat to avoid every flight receiving a rating of 5 or lower. A consistent lack of adequate cabin service may cause a rating to decrease. A transfer which requires a trip between terminals can require finding a bus outside a terminal may reduce a transfer rating to below 5.

A company may set limits on the allowable variation in the comfort level which will cause the rejection of a route. This level may depend on the role of the traveller within the company, such that a senior executive may require an average comfort level greater than 8 with a standard deviation less than 1, a middle level executive an average of 6 with a standard deviation of less than 1, and a worker an average of 5 with a standard deviation less than 1.2. Two trips are shown below, each of two sectors. In one the traveller is in business class, in the other in economy in one sector using cramped seating.

Breaking a route into comfort items with examples of actual trips:

| Phase | Good | Poor |
|---|---|---|
| Departure airport book in facilities | 8 | 8 |
| Emigration and Customs | 8 | 5 |
| Gate Lounge | 6 | 7 |
| Boarding | 7 | 5 |
| Flight Seat | 7 | 4 |
| Flight Service | 7 | 6 |
| Deplaning | 7 | 7 |
| Transit facilities | 8 | 7 |
| Airline transit facilities | 9 | 9 |
| Boarding | 7 | 7 |
| Flight Seat | 8 | 6 |
| Flight Service | 7 | 7 |
| Deplaning | 7 | 6 |
| Immigration Baggage and Customs | 6 | 5 |
| Transfer to taxi | 7 | 8 |
| Phase time total (hours) | 14.5 | 15.8 |
| Sum of points | 109 | 97 |
| Average points | 7.2 | 6.47 |
| Standard deviation (points) | 0.77 | 1.1 |

It can be seen that the average of the comfort levels is not greatly different, but the standard deviation is much greater, being affected by a longer boarding procedure, a poorer seat and an unfortunate problem retrieving baggage. Two of these things were predictable and would have caused a different route or an upgraded class to be provided at the time of booking had the inventive system been in use.

While many different methods of calculating a score for a level of comfort are possible each such method should easily be capable of providing an indication as to a potential balance between the travellers level of comfort and the cost of that comfort to the company. Since the level of comfort required by different corporate roles may allow a different level of cost the preferred route for the same journey may differ for different corporate roles. The algorithms are weighted by the individual profile together with the corporate role weightings to provide for this.

It should easily be possible to drill down into any particular choice to see perhaps what factors are contributing to a particular low score or to a particularly high score.

### VARIATIONS

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the invention is described in its application to an airline trip, but the system is equally applicable to a rail trip, a mixed air and rail trip, or a rental car tour between many cities in a country. The same criteria for “comfort” may be applied to arrive at a perceived best solution for the various phases of travel and transit or temporary residence.

Similarly while the use of a calculation system using averages and standard deviations is described many other methods of calculation or algorithms will provide indications as to whether a particular trip will provide an adequate comfort level for a traveller.

In addition, although the preferred embodiments described herein are directed to the use of such criteria in an ERP system, but it will be appreciated by those skilled in the art that variations and modifications are possible within the scope of the appended claims.

### INDUSTRIAL APPLICABILITY

The method of the invention is used in the derivation, transfer and correlation of data to aid in the process of booking travel through a corporate ERP system to provide a corporate traveller with travel which meets the corporations cost criteria while providing a certain minimum level of “comfort” for a corporate traveller. The present invention is therefore industrially applicable.

What we claim is:

1. A travel booking method which identifies the expected level of comfort of a travellers journey from one place to another when planning a travel route by identifying each sector of travel within that route, identifying the expected level of comfort of a traveller within that sector of travel, calculating the expected levels of comfort of each route and comparing travel routes made up of sectors of travel using standard statistical measures to indicate a travel route as that which provides a preferred expected level of comfort to the traveller.

2. A travel booking method as claimed in claim 1 wherein the factors of time, comfort, stress and risk associated with a trip are reduced to numerical factors in planning a trip.

3. A travel booking method as claimed in claim 1 wherein the trip cost is an additional factor in arriving at a preferred level of comfort for a journey.

4. A travel booking method as claimed in claim 1 wherein the statistical measures include a standard deviation calculation of the sum of individual factors.

5. A travel management system for booking travel having a storage system retaining information on:
sectors of travel journeys;
the information including at least some of:
the travel time of each sector of a journey;
the distance of each sector of a journey;
the percentile traveller build limitations of each sector of a journey;
the facilities available within each sector of a journey, the degree of confusion associated with being a traveller in each sector of a journey,
the number of time zones covered in each sector of a journey,
the risk associated with each sector of a journey;
traveller profiles including at least some of:
the traveller physical build percentile;
the traveller special food requirements;
the traveller special travel requirements;
the traveller special accommodation requirements;
a calculator calculating for each sector of a journey the potential level of comfort of the traveller within each sector on the basis of at least the specified factors,
a calculation system calculating the potential levels of comfort of the complete journey,
a display displaying the calculated potential level of comfort for the journey.

6. A travel management system as claimed in claim 5 wherein the calculations for multiple different routes of the same journey may be compared to decide the preferred journey route.

7. A travel management system as claimed in claim 5 wherein the travel management system may provide a display of the potential comfort levels of each sector and the factors making up that sectors potential comfort level.

8. A travel management system as claimed in claim 5 wherein the display of the potential levels of comfort of the whole journey include calculations of the standard deviation of the sectors and the factors making up the sectors.

9. A travel management system as claimed in claim 5 wherein the travel booking system includes a calculation of the risk level of each sector

10. A travel management system as claimed in claim 5 wherein the factors making up the potential comfort level are presented as a statistical compilation producing a single indicator for each journey.
